(19) United States
(12) Patent Application Publication
(10) Pub. No.: US 2018/0082501 A1
(43) Pub. Date: Mar. 22, 2018

(54) INTEGRATED ON-BOARD DATA COLLECTION

(71) Applicants: Ford Global Technologies, LLC, Dearborn, MI (US); Regents of the University of Michigan, Ann Arbor, MI (US)

(72) Inventors: Devinder Singh Kochhar, Ann Arbor, MI (US); Yi Murphey, Ann Arbor, MI (US)

(21) Appl. No.: 15/267,692

(22) Filed: Sep. 16, 2016

(51) Int. Cl. G07C 5/08; G06F 1/16; H04L 29/08

(52) U.S. Cl. CPC G07C 5/0866; H04L 67/12; G06F 1/163

(57) ABSTRACT

Systems and methods are disclosed for integrated on-board data collection from a solitary driver in a vehicle. An example disclosed includes cameras, a glove with first and second sensors, a vest with third and fourth sensors, and a sensor electronic module. The example sensor electronic module is communicatively coupled to the cameras, the glove, the vest, and a diagnostic port of a vehicle. The sensor electronic module monitors and records data from the cameras, the first second, third and fourth sensors, and electronic control units of the vehicle.

### TECHNICAL FIELD

The present disclosure generally relates to testing and validating features in vehicles and, more specifically, integrated on-board data collection.

### BACKGROUND

The design of a vehicle feature or function often requires extensive explorative experimentation and testing before the feature or function can be implemented into a commercially produced vehicle. For features or functions that interact with a driver, experimentation may be in a laboratory setting, such as in a simulator, or on a test track, or on a road/highway/lane in a town/city/municipality. The experimentation may require that the driver and vehicle be suitably equipped with monitoring instrumentation, and the ‘human-machine’ combination be driven along some route so that data can be collected. Most often, this requires a ride along observer that observes the driver.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for integrated on-board data collection. An example disclosed includes cameras, a glove with first and second sensors, a vest with third and fourth sensors, and a sensor electronic module. The example sensor electronic module is communicatively coupled to the cameras, the glove, the vest, and a diagnostic port of a vehicle. The sensor electronic module monitors and records data from the cameras, the first, second, third and fourth sensors, and electronic control units of the vehicle.

An examples method comprising includes monitoring a road and a driver with a first and second camera. The example method also includes monitoring physiological parameters of a driver with a glove that includes first and second sensors and a vest that includes third and fourth sensors. Additionally, the example method includes recording, in memory, the physiological parameters from the glove and the vest, and data of a vehicle via a diagnostic port of the vehicle, and images from the first and second camera.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a cabin of a vehicle with an integrated data collection system operating in accordance to the teachings of this disclosure.

FIG. 2 is a block diagram of electronic components of the vehicle and the instrumentation of FIG. 1.

FIG. 3 is a flowchart of a method to collect vehicle data and driver physiological data with the sensor electronics module of FIG. 1 that may be implemented by the electronic components of FIG. 2.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

New features in vehicles are tested to determine effects on a driver. For example, the effects may include distraction of the driver and/or comfort of the driver. As disclosed below, an integrated data collection comprises equipment to monitor and record vehicle communications data and equipment to monitor the driver. Vehicle data is data produced by electronic control units (ECUs) and sensors of the vehicle that is communicated via a vehicle data bus. For example, vehicle data may include the engine revolutions per minute (RPM), engine load, throttle position, vehicle lateral velocity, road curvature, brake pedal and acceleration pedal positions, angle of the steering wheel, etc. Equipment to monitor the vehicle includes, for example, an on-board diagnostic (e.g., OBD-II) interface to record the data from ECUs of the vehicle, a global positioning system (GPS) receiver, and a camera to record one or more views of the roads on which the vehicle is being driven. The equipment to monitor the driver measures the physiological reaction of the driver when driving. The equipment to monitor the driver includes, for example, a camera to track the gaze of the driver, a glove with galvanic skin response (GSR) sensor and an electromyogram (EMG) sensor, and a vest with an electrocardiogram (EKG) monitor and a respiration rate (RR) sensor. In some examples, the equipment to monitor the driver includes a cap with an electroencephalogram (EEG) monitor. The equipment to monitor the vehicle and the equipment to monitor the driver are communicatively coupled (via wired and/or wireless connections) to a sensor electronics module that aggregates and stores the data for future analysis. In such a manner, the driver is able to drive in a natural manner without a proscribed course or the need for a ride-along observer in the vehicle.

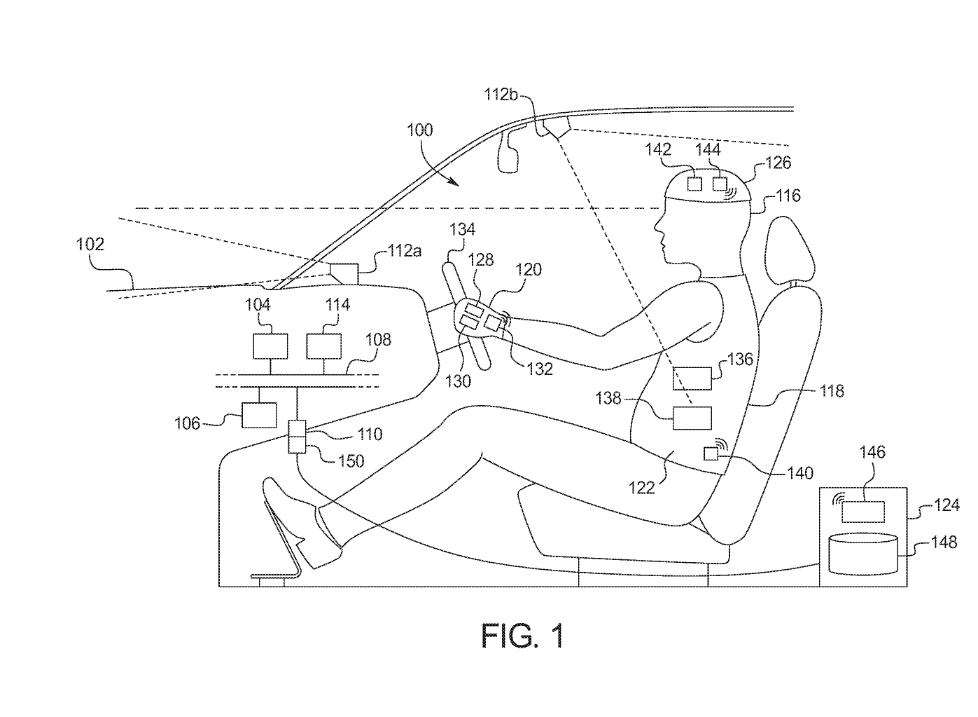

FIG. 1 illustrates a cabin 100 of a vehicle 102 with an integrated data collection system operating in accordance to the teachings of this disclosure. The vehicle 102 may be a standard gasoline powered vehicle, a hybrid vehicle, an electric vehicle, a fuel cell vehicle, and/or any other mobility implement type of vehicle. The vehicle 102 includes parts related to mobility, such as a powertrain with an engine, a transmission, a suspension, a driveshaft, and/or wheels, etc. The vehicle 102 may be non-autonomous, semi-autonomous (e.g., some routine motive functions controlled by the vehicle 102), or autonomous (e.g., motive functions are controlled by the vehicle 102 without direct driver input). In the illustrated example the vehicle 102 includes electronic control units (ECUs) 104, sensors 106, a vehicle data bus 108, a diagnostic port 110, and cameras 112a and 112b. In some examples, the vehicle 102 includes a global positioning (GPS) receiver 114.

The ECUs 104 monitor and control the subsystems of the vehicle 102. The ECUs 104 communicate and exchange information via a vehicle data bus (e.g., the vehicle data bus 108). Additionally, the ECUs 104 may communicate vehicle data (such as, status of the ECU 104, sensor readings, control state, error and diagnostic codes, etc.) to and/or receive requests from other ECUs 104. Some vehicles 102 may have seventy or more ECUs 104 located in various locations around the vehicle 102 communicatively coupled by the vehicle data bus 108. The ECUs 104 are discrete sets of electronics that include their own circuit(s) (such as integrated circuits, microprocessors, memory, storage, etc.) and firmware, sensors, actuators, and/or mounting hardware. The ECUs 104 may include, for example, a brake control unit, an engine control unit, a body control unit, and an infotainment head unit, etc.

The sensors 106 may be arranged in and around the vehicle 102 in any suitable fashion. The sensors 106 may be mounted to measure properties around the exterior of the vehicle 102. Additionally, some sensors 106 may be mounted inside the cabin of the vehicle 102 or in the body of the vehicle 102 (such as, the engine compartment, the wheel wells, etc.) to measure properties in the interior of the vehicle 102. For example, such sensors 106 may include accelerometers, odometers, tachometers, pitch and yaw sensors, wheel speed sensors, microphones, tire pressure sensors, and biometric sensors, etc.

The vehicle data bus 108 communicatively couples the ECUs 104, the sensors 106, the diagnostic port 110, and, in some examples, the GPS receiver 114. The vehicle data bus 108 may be organized on separate data buses to manage, for example, safety, data congestion, data management, etc. For example, the sensitive ECUs 104 (e.g., the brake control unit, the engine control unit, etc.) may be on a separate bus from the other ECUs 104 (e.g., the body control unit, the infotainment head unit, etc.). The vehicle data bus 108 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet bus protocol, etc.

The diagnostic port 110 is a connector configured to receive, for example, a cable or a telemetric control unit. In some examples, the diagnostic port 110 is implemented in accordance with the On-Board Diagnostic II (OBD-II) specification (e.g., SAE J1962 and SAE J1850) maintained by the Society of Automotive Engineers (SAE). In some examples, the diagnostic port 110 is under or near an instrument panel cluster of the vehicle 102. When a device (e.g., the sensor electronics module 124) is plugged into the diagnostic port 110, it is communicatively coupled to the vehicle data bus 108. The device receives signal data from the ECUs 104 via the diagnostic port 110.

A first camera 112a is positioned to capture images in front of the vehicle 102. Images captured by the first camera are analyzed to determine attributes of the road on which the vehicle 102 is driving. For example, the images from the first camera 112a may be analyzed to determine road curvature, lane width, left and right lane markings, lateral offset, and/or road surface condition, etc., and other vehicular or other traffic on the road, and environmental conditions such as rain, drizzle, bright luminance, or cloudy conditions. A second camera 112b is positioned to capture at least the head 116 of a driver 118, and, where possible, the direction of the driver's gaze. Images captured by the second camera 112b are analyzed to track a gaze of the driver 118 to determine whether the driver 118 is looking at the road (e.g., ahead of the vehicle), or elsewhere.

The GPS receiver 114 provides the coordinates of the vehicle 102. While the term “GPS receiver” is used here, the GPS receiver 114 may be compatible with any global navigation satellite system (e.g., GPS, a Global Navigation Satellite System (GLONASS), Galileo Positioning System, BeiDou Navigation Satellite System, etc.).

The example data collection system includes gloves 120, a vest 122, and a sensor electronics module 124. In some examples, the data collection system includes a cap 126. The gloves 120, the vest 122 and, in some examples, the cap 126 measure the physiological data of the driver 118. The sensor electronics module 124 collects and stores the vehicle data from the vehicle 102 and the physiological data of the driver 118.

In the illustrated examples, the gloves 120 include a galvanic skin response (GSR) sensor 128, an electromyogram (EMG) sensor 130, and a wireless node 132. The GSR sensor 128 measures the sweat and/or moisture in the fingers of the driver 118. Measurements from the GSR sensor 128 are used to gauge the stress of the driver 118. The EMG sensor 130 measures subcutaneous muscle movement by detecting electrical impulses in the muscles of the hands of the driver 118. Measurements from the EMG sensor 130 are used to gauge the forcefulness of the grip of the driver 118 on a steering wheel 134. In the illustrated example, the wireless node 132 communicatively couples the GSR sensor 128 and the EMG sensor 130 to the sensor electronics module 124. The wireless node 132 includes hardware and firmware communication over a short range wireless network, such as Bluetooth® Low Energy (as set forth in Volume 6 of the Bluetooth Specification 4.0 (and subsequent revisions) maintained by the Bluetooth Special Interest Group), Zigbee® (IEEE 802.15.4), and/or Wi-Fi® (including IEEE 802.11 a/b/g/n/ac or others). Alternatively, in some examples, the gloves 120 have a wired connection to the sensor electronics module 124.

The vest 122 includes an electrocardiogram (EKG) monitor 136, a respiration rate (RR) sensor 138, and a wireless node 140. The EKG monitor 136 includes pads (not shown) on the interior of the vest 122. Before wearing the vest, the driver 118 dampens the areas on the body of the driver 118 that will contact the pads to create a conductive path between the pads and the skin of the driver 118. The EKG monitor 136 measures electrical activity in the heart of the driver 118. The measurements are used to determine the stress and the workload of the driver 118. The RR sensor 138 measures expansion and compression of the chest of the driver 118 to determine a rate at which the driver is inhaling and exhaling. The wireless node 140 includes hardware and firmware communication over the short range wireless network (e.g. via Bluetooth® Low Energy, Zigbee®, and/or Wi-Fi®, etc.). Alternatively, in some examples, the vest 122 has a wired connection to the sensor electronics module 124.

The cap 126 includes an electroencephalogram (EEG) monitor 142 and a wireless node 144. The EEG monitor 142 monitors the electrical activity of the brain of the driver. The EEG monitor 142 includes electrodes that, when the cap 126 is worn by the driver 118, contact the scalp of the driver 118. The measurements from the EEG monitor 142 are analyzed, for example, to determine the emotional state of the driver 118 and/or the workload of the driver 118, as determined, in part, from the Delta, Theta, Alpha and Beta waves from the EEG The wireless node 144 includes hardware and firmware communication over the short range wireless network (e.g. via Bluetooth® Low Energy, Zigbee®, and/or Wi-Fi®, etc.). Alternatively, in some examples, the cap 126 has a wired connection to the sensor electronics module 124 (e.g., via the vest 122).

The gloves 120, the vest 122 and, in some examples, the cap 126 are electrically connected to a battery (not shown) to supply power to the various sensors 128, 130, 136, 138, and 142. In some examples, wires to supply power are routed from the gloves 120 and the cap 126 to the vest 122 to the battery which may be positioned on a seat next to the driver 118. Alternatively, in some examples, the battery is built into the vest to promote mobility of the driver 118.

The sensor electronics module 124 is wirelessly coupled to the gloves 120, the vest 122 and, in some examples, the cap 126 via a wireless node 146. Alternatively, in some examples, the sensor electronics module 124 has a wired connection to the gloves 120, the vest 122, and/or the cap 126. The sensor electronics module 124 samples data from the sensors and stores the samples data into a data collection database 148. In some examples, the sensor electronics module 124 samples the EKG monitor 136 at 256 Hz. In some such examples, the sensor electronics module 124 down-samples the measurements from the EKG monitor 136 to 1 Hz. In some examples, the sensor electronics module 124 samples the RR sensor 138 at 25.6 Hz. In some examples, the sensor electronics module 124 samples the GSR sensor 128 and EMG sensor 130 at 2 Hz.

The sensor electronics module 124 includes a connector 150 connects to the diagnostic port 110. In the illustrated example, the connector 150 has a wired connection with the sensor electronics module 124. Alternatively, in some examples, the connector 150 includes a wireless node (not shown) to establish a wireless connection with the sensor electronics module 124. From time-to-time (e.g, periodically, a periodically), the sensor electronic module interrogates the ECUs 104 and/or the sensors 106 via the diagnostic port 110. The sensor electronics module 124 records the signal data from the ECUs 104 and/or the sensors 106 in the data collection database 148. In some examples, the signal data includes coordinates of the vehicle 102 from the GPS receiver 114. Alternately or additionally, in some examples, the sensor electronics module 124 includes a GPS receiver to record the coordinates of the vehicle 102.

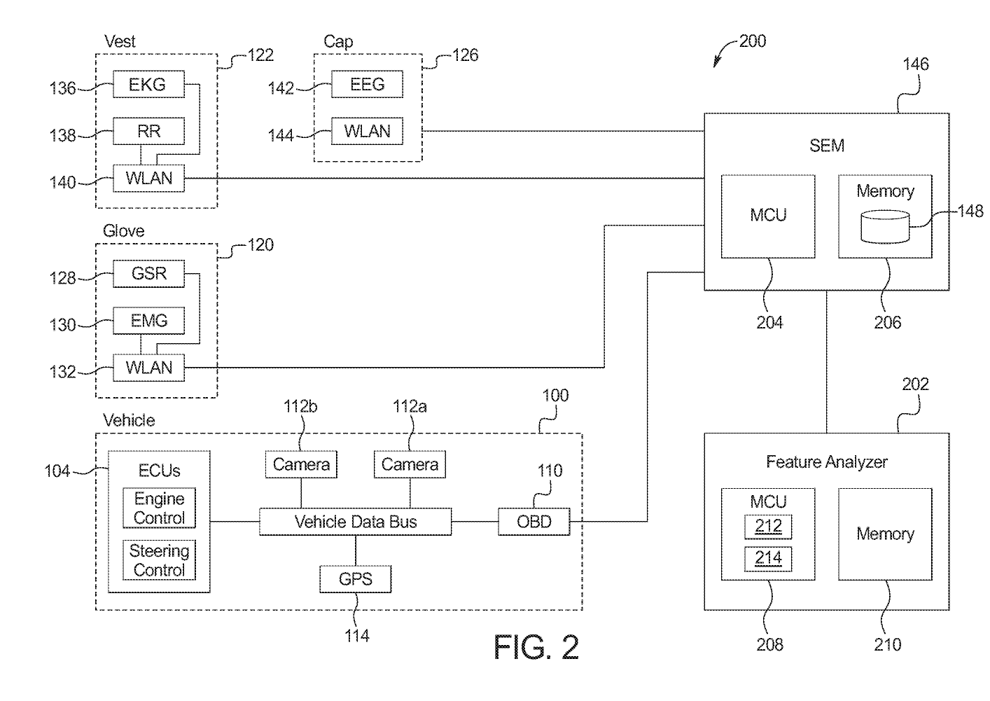

FIG. 2 is a block diagram of electronic components 200 of the vehicle 102 and the instrumentation 120, 122, and 126 of FIG. 1. In the illustrated example, the gloves 120, the vest 122, and the cap 126 are communicatively coupled via a wired or wireless connection to the sensor electronics module 124. Additionally, the sensor electronics module 124 is communicatively coupled to the vehicle 102 via a connector 150 plugged into the diagnostic port 110. In the illustrated example, the sensor electronics module 124 is communicatively coupled to a feature analyzer 202. In some examples, the sensor electronics module 124 is located inside the vehicle 102 and the feature analyze 202 is located outside of the vehicle 102. For example, the feature analyze 202 may be location in a garage or a laboratory, and the sensor electronics module 124 may be connected to the feature analyze 202 when the vehicle 102 is in the garage or the laboratory, or even outside, in a parking lot.

In the illustrated example, the sensor electronics module 124 includes a processor or controller 204 and memory 206. The processor or controller 204 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 206 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 206 includes multiple kinds of memory, particularly volatile memory and non-volatile memory.

The memory 206 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 206, the computer readable medium, and/or within the processor 204 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The feature analyzer 202 includes a processor or controller 208 and memory 210. The processor or controller 208 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 210 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 210 includes multiple kinds of memory, particularly volatile memory and non-volatile memory.

The memory 210 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 210, the computer readable medium, and/or within the processor 208 during execution of the instructions.

In the illustrated example, the processor or controller 208 of the feature analyzer 202 is structured to include an aggregator 212 and an analyzer 214. The aggregator 212 compiles the vehicle data and the physiological data stored in the data collection database of the sensor electronics module 124. The aggregator 212 aligns the vehicle data and the physiological data so that data with disparate sampling rates is correlated. For example, the data may be aligned into one second intervals. The analyzer 214 analyzes the aggregated data to evaluate a new feature installed in the vehicle 102. The analyzer may, for example, determine the workload of the driver 118, whether the driver was distracted, and/or whether the driver 118 was stressed. For example, the analyzer 214 may perform statistical analysis on the aggregated data.

Additionally, in some examples, the feature analyzer 202 includes input devices and output devices to receive input from the user(s) and display information. The input devices may include, for example, a keyboard, a mouse, a touchscreen, ports (e.g., universal serial bus (USB) ports, Ethernet ports, serial ports, etc.). The output devices may include, for example, a display (e.g., a light emitting diode (LED) display, an organic light emitting diode (OLED) display, a liquid crystal display, a cathode ray tube display (CRT), a touchscreen, a printer and/or speakers, etc.

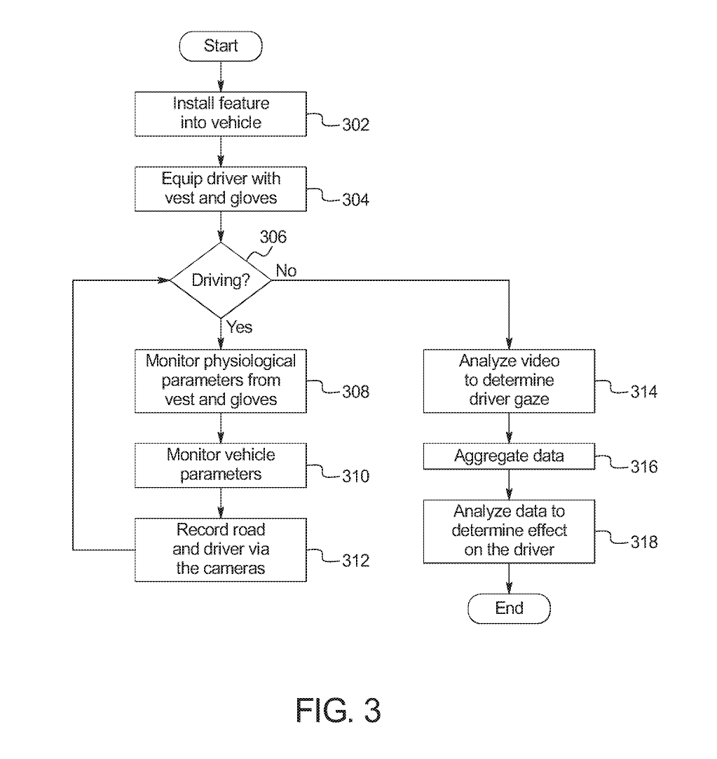

FIG. 3 is a flowchart of a method to collect vehicle data and driver physiological data with the sensor electronics module 124 of FIG. 1 that may be implemented by the electronic components 200 of FIG. 2. Initially, at block 302, a new feature is installed in the vehicle 102. For example, a new user interface for an infotainment system or a new blind spot detection system may be installed into the vehicle 102. At block 304, the driver 118 wears the gloves 120 and the vest 122. In some examples, the driver 118 also wears the cap 126. At block 306, the sensor electronics module 124 determines whether the vehicle 102 is being driven. For example, the sensor electronics module 124 may monitor data from a wheel speed sensor of the vehicle 102 and/or monitor the coordinates from the GSP receiver 114. If the vehicle 102 is being driven, the method continues at block 308. Otherwise, if the vehicle 102 is not being driven, the method continues at block 314.

At block 308, the sensor electronics module 124 monitors and records the physiological data from the glove 120, the vest 122 and, in some examples, the cap 126. For example, the sensor electronics module 124 may receive data from the GSR sensor 128 in the gloves 120 and the EKG monitor 136 in the vest 122. At block 310, the sensor electronics module 124 monitors and records the vehicle data from the ECUs 104 and the sensors 106 of the vehicle 102 via the diagnostic port 110. For example, the sensor electronics module 124 may receive the vehicle lateral velocity from the wheel speed sensor, the acceleration pedal position from the engine control unit, and the brake pedal position from the brake control unit at block 312, the sensor electronics module 124 records images from the cameras 112a and 112b.

At block 314, the feature analyzer 202 analyzes the images captured by the second camera 112b to determine the gaze of the driver 118. At block 316, the feature analyzer 202 aggregates and aligns the data and the physiological data so that data with disparate sampling rates a correlated. At block 318, the feature analyzer 202 analyzes the aggregated data to determine an effect of the driver 18 of the new feature.

The flowchart of FIG. 3 is representative of machine readable instructions stored in memory (such as the memory 206 and 210 of FIG. 2) that comprise one or more programs that, when executed by a processor (such as the processors 204 and 208 of FIG. 2), to implement the example sensor electronics module 124 of FIGS. 1 and 2 and the example feature analyzer 202 of FIG. 2. Further, although the example program(s) is/are described with reference to the flowchart illustrated in FIG. 3, many other methods of implementing the example sensor electronics module 124 and the example feature analyzer 202 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1. A system to evaluate a feature in a vehicle comprising:
cameras;
a glove with a first sensor;
a vest with a second sensor and conductive pads to create a conductive path between skin of a user and the second sensor;
a sensor electronic module communicatively coupled to the cameras, the glove, the vest, and a diagnostic port of the vehicle, the sensor electronic module to monitor and record data from the cameras, the first and second sensors, and electronic control units of the vehicle; and
a feature analyzer communicatively coupled to the sensor electronic module, the feature analyzer to align the data from the cameras and the electronic control units and the data from the first and second sensors.

2. The system of claim 1, wherein the first sensor is a galvanic skin response sensor.

3. The system of claim 1, wherein the glove includes a third sensor, the third sensor being an electromyogram sensor.

4. The system of claim 1, wherein the second sensor is an electrocardiogram monitor.

5. The system of claim 1, wherein the vest includes a third sensor, the third sensor being a respiration rate sensor that measures expansion and compression of a chest of the user.

6. The system of claim 1, including a cap that includes an electroencephalogram monitor, the electroencephalogram monitor being communicatively coupled to the sensor electronic module.

7. The system of claim 1, wherein the sensor electronic module monitors and records signal data from the vehicle, the data including engine revolutions per minute, engine load, throttle position, vehicle lateral velocity, brake pedal and acceleration pedal positions, and an angle of a steering wheel of the vehicle.

8. The system of claim 1, wherein one of the cameras is positioned to capture images of a road in front of the vehicle, and a second one of the cameras is positioned to capture images of a face of a driver.

9. The system of claim 1, wherein the feature analyzer analyzes data of physiological parameters received from the glove and the vest and vehicle data received from the vehicle to determine workload of a driver while driving the vehicle.

10. A method comprising:
monitoring a driver coupled with sensors to acquire data of physiological parameters of the driver; and
recording in memory, with a processor, the physiological parameters from the sensors and signal data of electronic control units of a vehicle via a diagnostic port of the vehicle; and
aligning, with the processor, the data of the physiological parameter and the signal data.

11. The method of claim 10, wherein at least one of the sensors is a galvanic skin response sensor.

12. The method of claim 10, wherein at least one of the sensors is an electromyogram sensor.

13. The method of claim 10, wherein at least one of the sensors is an electrocardiogram monitor.

14. The method of claim 10, wherein at least one of the sensors is a respiration rate sensor that measures expansion and compression of a chest of the driver.

15. The method of claim 10, including monitoring brainwave activity of the driver via a cap that includes an electroencephalogram monitor.

16. The method of claim 10, wherein the signal data include vehicle data defining at least one of engine revolutions per minute, engine load, throttle position, vehicle lateral velocity, brake pedal and acceleration pedal positions, and an angle of a steering wheel of the vehicle.

17. The method of claim 10 further comprising, monitoring a road and the driver with at least one first camera and at least one second camera, the at least one first camera positioned to capture images of a road in front of the vehicle and the at least one second cameras positioned to capture images of a face of the driver.

18. The method of claim 10, including analyzing the data of the physiological parameters and the signal data to determine whether the driver was distracted while driving the vehicle.

19. The method of claim 10, wherein monitoring and recording the data of the physiological parameters and the signal data is performed without a prescribed route and a proscribed destination.

20. The method of claim 10, wherein monitoring and recording the data of the physiological parameters and the signal data is performed without a passenger acting in a supervisory role to facilitate the monitoring and the recording of the data of the physiological parameters and the signal data.
